(19) United States
(12) Patent Application Publication
(10) Pub. No.: US 2013/0096232 A1
(43) Pub. Date: Apr. 18, 2013

(54) CURABLE EPOXY RESIN COMPOSITIONS AND COMPOSITES MADE THEREFROM

(71) Applicants: Theophanis Theophanous, Lake Jackson, TX (US); Kandathil E. Verghese, Lake Jackson, TX (US); George C. Jacob, Lake Jackson, TX (US)

(72) Inventors: Theophanis Theophanous, Lake Jackson, TX (US); Kandathil E. Verghese, Lake Jackson, TX (US); George C. Jacob, Lake Jackson, TX (US)

(21) Appl. No.: 13/805,688

(22) PCT Filed: Jun. 22, 2011
(86) PCT No.: PCT/US2011/041318

§ 371 Date: Dec. 20, 2012

Related U.S. Application Data
(60) Provisional application No. 61/358,742, filed on Jun. 25, 2010.

(51) Int. Cl. C08L 63/00; C08K 7/14

(52) U.S. Cl. CPC C08L 63/00; C08K 7/14
USPC 523/400

(57) ABSTRACT

A diluent-free curable epoxy resin composition for preparing a composite comprising: (A) at least one epoxy resin composition comprising a blend of: (A1) at least one epoxy resin, and (A2) at least one divinylarene dioxide; and (B) at least one hardener composition; and (C) at least one reinforcement materials; wherein the viscosity of the curable composition is the range of from about 0.15 Pa-s to about 1.5 Pa-s; and wherein the curable composition is adapted for providing a cured composite product made from the curable composition such that the composition being cured provides a cured composite product having an increased Tg of greater than about 5° C. as compared to a curable composition having a reactive diluent.

### BACKGROUND OF THE INVENTION

1. Field of the Invention

This invention relates to curable epoxy resin compositions substantially-free (or diluent-free) of reactive diluents, and composites made therefrom. More specifically, this invention relates to curable epoxy resin compositions utilizing a divinylarene dioxide such as divinylbenzene dioxide that provides curable epoxy resin compositions, and composites made therefrom, wherein the compositions have enhanced performance properties such as reduced processing time, lower viscosity, and increased Tg, strength and toughness.

The epoxy resin compositions of the present invention may be useful, for example, for fabricating clear castings, composites, coatings and adhesives.

2. Description of Background and Related Art

It is known that, in order to obtain a resin composition having the required flow characteristics, i.e., the required viscosity, for preparing composites, coatings and adhesives, one or more diluents must be added to the resin composition. There are various known reactive diluents that can reduce the viscosity of resin formulations in order to provide the necessary flow of the composition to use in various curing processes. However, it also known that while reactive diluents reduce viscosity, the known reactive diluents do so in ways that are detrimental to the overall thermo-mechanical performance of the resulting cured product.

For example, composite parts are often made using resin infusion processes like Vacuum Assist Resin Transfer Molding (VARTM) and filament winding and the like. During composite fabrication using these resin infusion processes like VARTM, large amounts of resin formulation, for example in excess of 1000 kg, are infused under vacuum into a mold containing glass fibers as reinforcement material. The word “mold” refers to an object that is used to make and provide the final desired shape to the composite part. The mold can be rigid (metallic or composite based) or flexible and can either form a cavity (closed mold) or a mandrel onto which the composite is fabricated. It is important for the resin composition to have a viscosity of, for example, less than about 1.5 Pa-s at room temperature during infusion because this low viscosity is critical to ensure that the resin composition thoroughly wets the glass fiber reinforcement material. Insufficient wetting of the fibers (as evidenced by dry fibers) by the resin composition can often lead to dry spots causing premature failure due to de-lamination of the resultant composite part; for example a wind turbine blade, made from such resin composition.

As aforementioned, resin viscosities are often achieved to an acceptable processing level for hot melt prepregging by using reactive or non reactive diluents. The use of these diluents can reduce viscosity of the resin composition; however, the use of these diluents can also be detrimental to the overall thermo-mechanical performance of the resultant cured product manufactured from curing the resin composition. For example, important properties such as glass transition temperature (Tg) can be decreased, chemical and solvent resistance can be reduced, and other properties of the final cured composite product can be lost.

### SUMMARY OF THE INVENTION

The present invention is directed to eliminating the use of known conventional diluents in a formulated curable epoxy resin composition such that when a final cured composite product is made from the curable epoxy resin composition, the properties of the final cured composite product will not be detrimentally affected.

In one embodiment of the present invention, a divinylarene dioxide such as for example divinylbenzene dioxide (DVBDO) is used in a resin system such that the use of reactive or non-reactive diluents in the system can be negated or at least reduced in concentration to an amount that lowers the viscosity level of the system sufficiently to acceptable levels (e.g. less than about 1.5 Pa-s) to be useful in the fabrication of composites such as in resin infusion composite fabrications processes. For example, large composite parts, such as composite parts that are greater than about 6.25 mm in thickness, are often made using resin infusion processes like VARTM. During composite fabrication using these resin infusion processes like VARTM, large amounts of resin formulation, e.g. in excess of about 1000 Kg, are infused under vacuum into a mold containing glass reinforcements.

The present invention provides curable resin formulations having a viscosity during infusion low enough (e.g. less than about 1.5 Pa-s) to ensure complete wetting of the glass fibers without the use of added diluents. The present invention also prevents dry spots from forming in the glass fiber reinforcement material and thus, preventing premature failure of the composite part. In addition the present invention provides a final cured composite panel product with an increase in Tg, stiffness and toughness; and minimal compromise in chemical and solvent resistance.

Since a DVBDO-based system has a viscosity of for example about 0.012 Pa-s to start with, only a reduced amount of diluent or “no diluent” will be required to be added to this formulation to have the viscosity within an acceptable processing level for composite fabrication. For example, the viscosity of the resin can be less than about 1.5 Pa-s for Liquid Composite Molding (including for example VARTM, resin transfer molding (RTM), resin film infusion (RFI) molding, etc.); from about 1 Pa-s to about 3 Pa-s for filament winding; from about 0.5 Pa-s to about 3 Pa-s for pultrusion; and from about 20 Pa-s to about 30 Pa-s for hot melt prepregging. If reduced amounts of diluents or no diluents are used, benefits are obtained such as increased Tg, increased chemical resistance, increased solvent resistance, and improvements in other properties such as increased strength and increased toughness of the final composite part such as a composite panel.

One embodiment of the present invention is directed to a diluent-free curable resin composition or system including a curable epoxy resin composition comprising (a) an epoxy resin such as for example diglycidyl ether of bisphenol A, diglycidyl ether of bisphenol F, cycloaliphatic epoxies, or mixtures thereof; (b) a curing agent; and (c) a divinylarene dioxide such as DVBDO, or blends thereof; wherein the divinylarene dioxide is present in the curable resin composition in a sufficient concentration such that the toughness of the resulting cured product is increased by at least 10 percent (%) as compared with a cured product made from a curable composition without the divinylarene dioxide. In other embodiments, the viscosity of the uncured resin composition remains substantially unchanged or is not increased to a level that would require a conventional diluent.

“Substantially free of diluent,” “diluent-free” or “no diluent” with reference to a resin composition, herein means a resin composition that uses less than a conventional amount of a diluent compound or does not use a diluent compound at all; wherein the diluent compound's sole function is to reduce viscosity of the resin composition. For example, a resin composition to be substantially free of diluent, the diluent concentration in the resin composition is generally less than about 30 weight percent (wt %), preferably less than about 15 wt %, more preferably less than about 5 wt %, and most preferably zero wt %.

The present invention composition contains a sufficient amount of a divinylarene dioxide that is capable of accommodating a high loading (e.g. greater than 5 wt %) of toughening agent (TA) adapted to give the resin an appropriate toughness boost without causing the viscosity of the uncured formulation to substantially increase. In general, the increase in viscosity of the resin composition is not more than 20% increase, preferably not more than 10% increase, and more preferably not more than 5% increase in viscosity.

Other embodiments of the present invention include a process for making the above curable composition, a process for curing the curable composition and cured products made therefrom.

One advantage of the present invention, given the lower viscosity of DVBDO, includes the capability of formulating the curable resin of the present invention to accommodate a higher percent (e.g. greater than 5 wt %) of TA loading to give the appropriate toughness boost (e.g. greater than 20%) without causing the viscosity of the uncured formulation to increase beyond processable conditions. For example, the viscosity of the resin of the present invention may be less than about 1.5 Pa-s for Liquid Composite Molding (e.g., less than 1 Pa-s for VARTM), from about 1 Pa-s to about 3 Pa-s for filament winding, from about 0.5 Pa-s to about 3 Pa-s for pultrusion, and from about 20 Pa-s to about 30 Pa-s for hot melt prepregging. Hence there will not be a need to add any diluents to the get viscosity under control for processing needs. Not adding a diluent to an epoxy resin formulation will result in no Tg loss as would be the case with traditional epoxy formulations wherein diluents need to be added to counter the viscosity increase due to the

TA addition thus resulting in Tg loss of the cured formulation. As a result, a superior viscosity-Tg-stiffness-toughness balance can be maintained by employing the resin composition of the present invention.

In some instances in the prior art, particularly when curing an epoxy resin, for example DER® 383, with a curing agent such as triethylenetetraamine (TETA) commercially available as DEH®20 from The Dow Chemical Company, a higher starting viscosity coupled with a faster rheo-kinetics (e.g. a viscosity higher than about 1 Pa-s in less than about 5 minutes), makes it impossible to make a composite via infusion. The addition of approximately 14% of a divinylarene dioxide to the formulation makes the present invention system processable (e.g. the curable resin formulation has a viscosity of less than about 1 Pa-s) resulting in a good quality composite (i.e., no visual voids are visually observed in the final composite).

### BRIEF DESCRIPTION OF THE DRAWINGS

For the purpose of illustrating the present invention, the drawings show a form of the present invention which is presently preferred. However, it should be understood that the present invention is not limited to the embodiments shown in the drawings.

FIG. 1 is a graphical illustration showing the effect of a divinylarene dioxide on the reduction of blend viscosity with DER 383.

FIG. 2A is a photomicrograph of a cured composite panel of the prior art showing dry spots formed on the panel when the panel is prepared from 100% DER 383 cured with DEH20.

FIG. 2B is a photomicrograph of a cured composite panel of the present invention showing no dry spots formed on the panel when the panel is prepared from a formulation containing DVBDO (8 6% DER 383+14% DVBDO cured with DEH20).

### DETAILED DESCRIPTION OF THE INVENTION

One broad aspect of the present invention includes a curable epoxy resin composition comprising (a) an epoxy resin; (b) a curing agent; and (c) a divinylarene dioxide; wherein the divinylarene dioxide is present in the curable resin composition in a sufficient concentration such that the toughness of the resulting cured product is increased by at least 10 percent as compared with a cured product made from a curable composition without the divinylarene dioxide.

In preparing the curable epoxy resin composition of the present invention, the composition may include at least one epoxy resin, component (a). Epoxy resins are those compounds containing at least one vicinal epoxy group. The epoxy resin may be saturated or unsaturated, aliphatic, cycloaliphatic, aromatic or heterocyclic and may be substituted. The epoxy resin may also be monomeric or polymeric. The epoxy resin useful in the present invention may be selected from any known epoxy resins in the art. An extensive enumeration of epoxy resins useful in the present invention is found in Lee, H. and Neville, K., “Handbook of Epoxy Resins,” McGraw-Hill Book Company, New York, 1967, Chapter 2, pages 257-307; incorporated herein by reference.

The epoxy resins, used in embodiments disclosed herein for component (a) of the present invention, may vary and include conventional and commercially available epoxy resins, which may be used alone or in combinations of two or more. In choosing epoxy resins for compositions disclosed herein, consideration should not only be given to properties of the final product, but also to viscosity and other properties that may influence the processing of the resin composition.

Particularly suitable epoxy resins known to the skilled worker are based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known to the skilled worker include reaction products of epichlorohydrin with o-cresol and, respectively, phenol novolacs. It is also possible to use a mixture of two or more epoxy resins.

The epoxy resin useful in the present invention for the preparation of the epoxy resin composition, may be selected from commercially available products. For example, D.E.R.® 331, D.E.R.332, D.E.R. 334, D.E.R. 580, D.E.N.® 431, D.E.N. 438, D.E.R. 736, or D.E.R. 732 available from The Dow Chemical Company may be used. As an illustration of the present invention, the epoxy resin component (a) may be a liquid epoxy resin, D.E.R. 383 (diglycidyl ether of bisphenol A) having an epoxide equivalent weight of 175-185, a viscosity of 9.5 Pa-s and a density of 1.16 g/cc. Other commercial epoxy resins that can be used for the epoxy resin component can be D.E.R. 330, D.E.R. 354, or D.E.R. 332.

Other suitable epoxy resins useful as component (b) are disclosed in, for example, U.S. Pat. Nos. 3,018,262. 7,163,973, 6,887,574, 6,632,893, 6,242,083, 7,037,958, 6,572,971, 6,153,719, and 5,405,688, PCT Publication WO 2006/052727; U.S. Patent Application Publication Nos. 20060293172, 20050171237, 2007/0221890 A1; each of which is hereby incorporated herein by reference.

In a preferred embodiment, the epoxy resin useful in the composition of the present invention comprises any aromatic or aliphatic glycidyl ether or glycidyl amine or a cycloaliphatic epoxy resin.

The composition of the present invention may include other resins such as diglycidyl ether of bisphenol A, diglycidyl ether of bisphenol F, cycloaliphatic epoxies, multifunctional epoxies, or resins with reactive and non-reactive diluents.

In general, the choice of the epoxy resin used in the present invention depends on the application. However, diglycidyl ether of bisphenol A (DGEBA) and derivatives thereof are particularly preferred. Other epoxy resins can be selected from but limited to the groups of: bisphenol F epoxy resins, novolac epoxy resins, glycidylamine-based epoxy resins, alicyclic epoxy resins, linear aliphatic and cycloaliphatic epoxy resins, tetrabromobisphenol A epoxy resins, and combinations thereof.

In general, the composition may include from about 1 wt % to about 99 wt % the second thermosetting resin. In other embodiments, the composition may include from about 1 wt % to about 50 wt % second thermosetting resin; from about 1 wt % to about 30 wt % second thermosetting resin in other embodiments; from about 1 wt % to about 20 wt % second thermosetting resin in other embodiments; and from about 1 wt % to about 10 wt % second thermosetting resin in yet other embodiments.

The curing agent, component (b), useful for the curable epoxy resin composition of the present invention, may comprise any conventional curing agent known in the art for curing epoxy resins. The curing agents, (also referred to as a hardener or cross-linking agent) useful in the thermosettable composition, may be selected, for example, from those curing agents well known in the art including, but are not limited to, anhydrides, carboxylic acids, amine compounds, phenolic compounds, polyols, or mixtures thereof.

Examples of curing agents useful in the present invention may include any of the co-reactive or catalytic curing materials known to be useful for curing epoxy resin based compositions. Such co-reactive curing agents include, for example, polyamine, polyamide, polyaminoamide, dicyandiamide, polyphenol, polymeric thiol, polycarboxylic acid and anhydride, and any combination thereof or the like. Suitable catalytic curing agents include tertiary amine, quaternary ammonium halide, Lewis acids such as boron trifluoride, and any combination thereof or the like. Other specific examples of co-reactive curing agent include phenol novolacs, bisphenol-A novolacs, phenol novolac of dicyclopentadiene, cresol novolac, diaminodiphenylsulfone, styrene-maleic acid anhydride (SMA) copolymers; and any combination thereof. Among the conventional co-reactive epoxy curing agents, amines and amino or amido containing resins and phenolics are preferred.

Preferably, the resin systems of the present invention can be cured using various standard curing agents including for example, amines, anhydrides and acids, phenolics and mixtures thereof.

Dicyandiamide may be one embodiment of the curing agent useful in the present invention. Dicyandiamide has the advantage of providing delayed curing since dicyandiamide requires relatively high temperatures for activating its curing properties; and thus, dicyandiamide can be added to an epoxy resin and stored at room temperature (about 25° C.).

Generally, the amount of curing agent used is at stoichiometric balance or less based on equivalents compared to that of the epoxide groups. For example, in general, the composition may include from about 1 wt % to about 70 wt % of the curing agent. In other embodiments, the composition may include from about 1 wt % to about 50 wt % curing agent; from about 1 wt % to about 30 wt % curing agent in other embodiments; from about 1 wt % to about 20 wt % curing agent in other embodiments; and from about 1 wt % to about 10 wt % curing agent in yet other embodiments.

The divinylarene dioxide, component (c), useful in the present invention may comprise, for example, any substituted or unsubstituted arene nucleus bearing one or more vinyl groups in any ring position. For example, the arene portion of the divinylarene dioxide may consist of benzene, substituted benzenes, (substituted) ring-annulated benzenes or homologously bonded (substituted) benzenes, or mixtures thereof. The divinylbenzene portion of the divinylarene dioxide may be ortho, meta, or para isomers or any mixture thereof. Additional substituents may consist of H₂O₂-resistant groups including saturated alkyl, aryl, halogen, nitro, isocyanate, or RO— (where R may be a saturated alkyl or aryl). Ring-annulated benzenes may consist of naphthlalene, tetrahydronaphthalene, and the like. Homologously bonded (substituted) benzenes may consist of biphenyl, diphenylether, and the like.

The divinylarene dioxide used for preparing the composition of the present invention may be illustrated generally by general chemical Structures I-IV as follows:

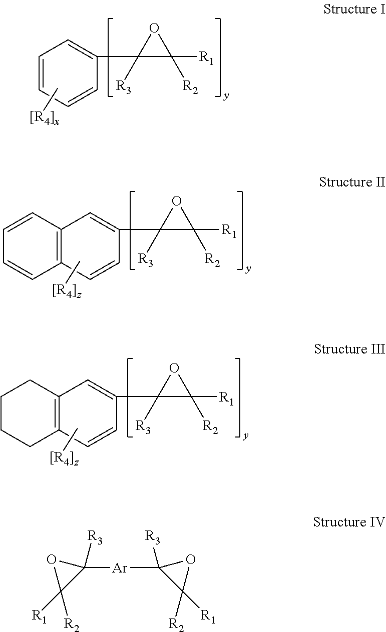

In the above Structures I, II, III, and IV of the divinylarene dioxide comonomer of the present invention, each R₁, R₂, R₃ and R₄ individually may be hydrogen, an alkyl, cycloalkyl, an aryl or an aralkyl group; or a H₂O₂-resistant group including for example a halogen, a nitro, an isocyanate, or an RO group, wherein R may be an alkyl, aryl or aralkyl; x may be an integer of 0 to 4; y may be an integer greater than or equal to 2; x+y may be an integer less than or equal to 6; z may be an interger of 0 to 6; and z+y may be an integer less than or equal to 8; and Ar is an arene fragment including for example, 1,3-phenylene group. In addition, R4 can be a reactive group(s) including epoxide, isocyanate, or any reactive group and Z can be an integer from 0 to 6 depending on the substitution pattern.

In one embodiment, the divinylarene dioxide used in the present invention may be produced, for example, by the process described in U.S. Patent Provisional Application Ser. No. 61/141,457, filed Dec. 30, 2008, entitled “Process for Preparing Divinylarene Dioxides”, by Marks et al., incorporated herein by reference. The divinyl-arene dioxide compositions that are useful in the present invention are also disclosed in, for example, U.S. Pat. No. 2,924,580, incorporated herein by reference.

In another embodiment, the divinylarene dioxide useful in the present invention may comprise, for example, divinylbenzene dioxide, divinylnaphthalene dioxide, divinylbiphenyl dioxide, divinyldiphenylether dioxide, and mixtures thereof.

In a preferred embodiment of the present invention, the divinylarene dioxide used in the epoxy resin formulation may be for example DVBDO. Most preferably, the divinylarene dioxide component that is useful in the present invention includes, for example, a DVBDO as illustrated by the following chemical formula of Structure V:

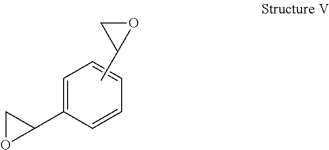

The chemical formula of the above DVBDO compound may be as follows: C₁₀H₁₀O₂; the molecular weight of the DVBDO is about 162.2; and the elemental analysis of the DVBDO is about: C, 74.06; H, 6.21; and O, 19.73 with an epoxide equivalent weight of about 81 g/mol.

Divinylarene dioxides, particularly those derived from divinylbenzene such as for example DVBDO, are class of diepoxides which have a relatively low liquid viscosity but a higher rigidity and crosslink density than conventional epoxy resins.

Structure VI below illustrates an embodiment of a preferred chemical structure of the DVBDO useful in the present invention:

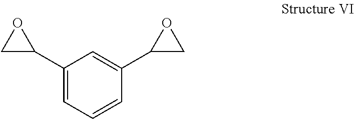 [SMILES: c1cc(C2CO2)cc(C2CO2)c1]

Structure VII below illustrates another embodiment of a preferred chemical structure of the DVBDO useful in the present invention:

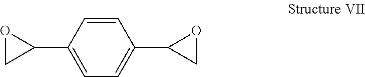 [SMILES: c1cc(C2CO2)ccc1C1CO1]

When DVBDO is prepared by the processes known in the art, it is possible to obtain one of three possible isomers: ortho, meta, and para. Accordingly, the present invention includes a DVBDO illustrated by any one of the above Structures individually or as a mixture thereof. Structures VI and VII above show the meta (1,3-DVBDO) and para isomers of DVBDO, respectively. The ortho isomer is rare; and usually DVBDO is mostly produced generally in a range of from about 9:1 to about 1:9 ratio of meta (Structure VI) to para (Structure VII) isomers. The present invention preferably includes as one embodiment a range of from about 6:1 to about 1:6 ratio of Structure VI to Structure VII, and in other embodiments the ratio of Structure VI to Structure VII may be from about 4:1 to about 1:4 or from about 2:1 to about 1:2.

In yet another embodiment of the present invention, the divinylarene dioxide may contain quantities (such as for example less than about 20 wt %) of substituted arenes. The amount and structure of the substituted arenes depend on the process used in the preparation of the divinylarene precursor to the divinylarene dioxide. For example, divinylbenzene prepared by the dehydrogenation of diethylbenzene (DEB) may contain quantities of ethylvinylbenzene (EVB) and DEB. Upon reaction with hydrogen peroxide, EVB produces ethylvinylbenzene monoxide while DEB remains unchanged. The presence of these compounds can increase the epoxide equivalent weight of the divinylarene dioxide to a value greater than that of the pure compound but can be utilized at levels of 0 to 99% of the epoxy resin portion.

In one embodiment, the divinylarene dioxide useful in the present invention comprises, for example, DVBDO, a low viscosity liquid epoxy resin. The viscosity of the divinylarene dioxide used in the process of the present invention ranges generally from about 0.001 Pa s to about 0.1 Pa s, preferably from about 0.01 Pa-s to about 0.05 Pa-s, and more preferably from about 0.01 Pa-s to about 0.025 Pa-s, at 25° C.

The concentration of the divinylarene oxide used in the present invention as the epoxy resin portion of the formulation may range generally from about 0.5 wt % to about 100 wt %, preferably, from about 1 wt % to about 99 wt %, more preferably from about 2 wt % to about 98 wt %, and even more preferably from about 5 wt % to about 95 wt % depending on the fractions of the other formulation ingredients.

The optional toughening agent, component (d), useful for the curable epoxy resin composition of the present invention, may comprise any conventional toughening agent known in the art for toughening epoxy resins systems. For example these systems may include toughening additives such as elastomers including for example carboxyl terminated liquid butadiene acrylonitrile rubber (CTBN), acrylic terminated liquid butadiene acrylonitrile rubber (ATBN), epoxy terminated liquid butadiene acrylonitrile rubber (ETBN); and liquid epoxy resin (LER) adducts of elastomers; preformed core-shell rubbers; and other typical toughening agents; and mixtures thereof.

In general, the curable epoxy resin composition of the present invention may include from about 0.1 wt % to about 40 wt % of the toughening agent. In other embodiments, the composition may include from about 0.1 wt % to about 30 wt % toughening agent; from about 0.1 wt % to about 20 wt % toughening agent in other embodiments; from about 0.1 wt % to about 10 wt % toughening agent in other embodiments; and from about 0.1 wt % to about 5 wt % toughening agent in yet other embodiments.

While the present invention is preferably diluent-free, in some instances, a skilled artisan may wish to add a small quantity of diluent to the curable composition of the present invention in order to reduce viscosity. The optional diluent, component (e), useful for the curable epoxy resin composition of the present invention, may comprise any conventional diluent known in the art useful for epoxy resins systems. For example, the curable epoxy resin composition may include 1,4-butanediol diglycidyl ether (BDDGE), 1,6 hexanediol diglycidyl ether (HDDGE), cresol diglycidyl ether (CGE), C12-14 alkyl glycidyl ether (AGE), trimethylol propane triglycidyl ether (TMPTGE); and mixtures thereof.

In general, the curable epoxy resin composition of the present invention may include from 0 wt % to about 50 wt % of the diluent. In other embodiments, the composition may include from about 0.1 wt % to about 30 wt % diluent; from about 0.1 wt % to about 20 wt % diluent in other embodiments; from about 0.1 wt % to about 10 wt % diluent in other embodiments; and from about 0.1 wt % to about 5 wt % diluent in yet other embodiments.

The curable or thermosettable composition of the present invention may optionally contain one or more other additives which are useful for their intended uses. For example, the optional additives useful in the present invention composition may include, but not limited to, catalysts, non reactive diluents, fillers, fibers, flame retardants stabilizers, surfactants, flow modifiers, pigments or dyes, matting agents, degassing agents, flame retardants (e.g., inorganic flame retardants, halogenated flame retardants, and non-halo-genated flame retardants such as phosphorus-containing materials), toughening agents, curing initiators, curing inhibitors, wetting agents, colorants or pigments, thermoplastics, processing aids, UV blocking compounds, fluorescent compounds, UV stabilizers, inert fillers, fibrous reinforcements, antioxidants, impact modifiers including thermoplastic particles, and mixtures thereof. The above list is intended to be exemplary and not limiting. The preferred additives for the, formulation of the present invention may be optimized by the skilled artisan.

When fibers are included in the curable epoxy resin composition of the present invention, the fibers can be in continuous, chopped and/or fabric form. The fibers can be composed of inorganic materials such as glass and carbon; or the fibers may be organic such as Kevlar, polyolefin, etc. Aspect ratios of the fibers can vary anywhere from about 1 to infinity (representing the continuous fiber case) and concentrations of the fibers in the curable epoxy resin composition of the present invention can vary from about 0.2 wt % to about 95 wt %; preferably between about 0.2 wt % to about 70 wt %; and most preferably between about 0.2 wt % to about 60 wt %.

In one preferred embodiment, the curable epoxy resin composition of the present invention may include a reinforcement material (C) comprising fibers having an aspect ratio of from about 0.25 to about infinity (representing the continuous fiber case); or wherein the reinforcement material (C) comprises inorganic glass fibers, basalt, carbon and organic, Kevlar, polyolefins or hybrids thereof, and fillers selected from the group consisting of calcium carbonate, clay, wollastonite, and mixtures thereof.

The concentration of the optional additional additives useful in the curable epoxy resin composition of the present invention is generally between about 0.01 wt % to about 60 wt %; preferably, between about 0.01 wt % to about 40 wt %; more preferably, between about 1 wt % to about 20 wt %; and most preferably, between about 1 wt % to about 10 wt % based on the weight of the total composition. At concentrations above these ranges, the properties of the curable composition are adversely affected.

In one preferred embodiment, the curable epoxy resin composition of the present invention, includes an epoxy resin (A1) comprising diglycidyl ether of bisphenol A, diglycidyl ether of bisphenol F, a cycloaliphatic epoxy, oxazolidone-containing epoxy, or mixtures thereof; a divinylarene dioxide resin (A2) comprising divinylbenzene dioxide resin; a curing agent (B) comprising an amine; anhydride; phenolic; acid; or mixtures thereof; and a reinforcement material (C) comprising fillers, fibers, fabrics, particulates, and mixtures thereof.

In one preferred embodiment, the curable epoxy resin composition of the present invention includes an epoxy resin, wherein the concentration of the epoxy resin (A1) comprises from about 40 weight percent to about 95 weight percent; a divinylarene dioxide resin, wherein the concentration of the divinylarene dioxide resin (A2) is from about 0.1 weight percent to about 50 weight percent; a curing agent, wherein the concentration of the curing agent (B) comprises from about 5 weight percent to about 60 weight percent; and a reinforcement material, wherein the concentration of reinforcement material (C) is from about 0.5 weight percent to about 95 weight percent.

The preparation of the curable epoxy resin composition of the present invention is achieved by admixing in a vessel the components of the present invention including an epoxy resin, a curing agent, a divinylarene dioxide, and any other optional components such as a catalyst and/or a solvent; and then allowing the components to formulate into an epoxy resin composition. There is no criticality to the order of mixture, i.e., the components of the composition of the present invention may be admixed in any order to provide the curable composition of the present invention. Any of the above-mentioned optional assorted composition additives, for example fillers, may also be added to the composition during the mixing or prior to the mixing to form the composition.

All the components of the epoxy resin composition are typically mixed and dispersed at a temperature enabling the preparation of an effective epoxy resin composition having a low viscosity for the desired application. The temperature during the mixing of all components may be generally from about 0° C. to about 100° C. and preferably from about 0° C. to about 50° C. At temperatures below the above ranges, the viscosity of the formulation or composition becomes excessive, while at temperatures above the ranges, the composition can react prematurely.

The epoxy resin composition of the present invention described above, have improved heat resistance at the same molecular weight or lower viscosity at the same heat resistance compared to known compositions in the art.

The viscosity of the curable epoxy resin composition of the present invention ranges generally from about 100 Pa-s to about 300000 Pa-s; preferably, from about 100 Pa-s to about 100000 Pa-s; and more preferably, from about 100 Pa-s to about 10000 Pa-s at 25° C.

The number average molecular weight (Mₙ) of the curable epoxy resin composition of the present invention ranges generally from about 150 daltons to about 15000 daltons; preferably, from about 250 daltons to about 10000 daltons; and more preferably, from about 350 daltons to about 1000 daltons.

These curable resins are room temperature (about 25° C.) cured or thermally cured with a wide range of curing agents that include for example, amines, anhydrides as well as acid cure.

The curable formulation or composition of the present invention can be cured under conventional processing conditions to form a thermoset. The resulting thermoset displays excellent thermo-mechanical properties, such as good toughness and mechanical strength, while maintaining high thermal stability.

The process to produce the thermoset products of the present invention may be performed by gravity casting, vacuum casting, automatic pressure gelation (APG), vacuum pressure gelation (VPG), infusion, filament winding, lay up injection, transfer molding, prepregging, dipping, coating, spraying, brushing, and the like.

The curing of the curable epoxy resin composition may be carried out at a predetermined temperature and for a predetermined period of time sufficient to partially cure or completely cure the composition and the curing may be dependent on the hardeners used in the formulation. For example, the temperature of curing the formulation may be generally from about 10° C. to about 200° C.; preferably from about 25° C. to about 100° C.; and more preferably from about 30° C. to about 90° C.; and the curing time may be chosen between about 1 minute to about 4 hours, preferably between about 5 minutes to about 2 hours, and more preferably between about 10 minutes to about 1 hour. Below a period of time of about 1 minute, the time may be too short to ensure sufficient reaction under conventional processing conditions; and above about 4 hours, the time may be too long to be practical or economical.

The curing process of the present invention may be a batch or a continuous process. The reactor used in the process may be any reactor and ancillary equipment well known to those skilled in the art.

In one embodiment, the process for preparing the cured composite product of the present invention includes placing the curable composition in a mold prior to the curing step.

In another embodiment, the process for preparing the cured composite product of the present invention includes a liquid composite molding process, a pultrusion process, a filament winding process, or a hot melt prepregging process.

In still another embodiment, the process for preparing the cured composite product of the present invention includes a liquid composite molding process comprising a VARTM process, a RTM process, a Vacuum Infusion process, or an injection molding process.

The cured or thermoset product prepared by curing the epoxy resin composition of the present invention advantageously exhibits an improved balance of thermo-mechanical properties (e.g. transition temperature, modulus, and toughness). The cured product can be visually transparent or opalescent.

The thermoset product or cured product (i.e. the cross-linked product made from the curable epoxy resin composition) of the present invention shows several improved properties over conventional epoxy cured resins. For example, the cured product of the present invention may have a glass transition temperature (Tg) of from about −55° C. to about 200° C. Generally, the Tg of the resin is higher than about −60° C., preferably higher than about 0° C., more preferably higher than about 10° C., more preferably higher than about 25° C., and most preferably higher than about 50° C.; as measured by Dynamic Mechanical Thermal Analyzer or Differential Scanning Calorimetry. Below about −55° C., the technology described in this application does not provide any further significant advantage versus the conventional technology described in the prior art; and above about 200° C., the technology described in the present application generally would lead to a very brittle network without the inclusion of toughening technologies which is not suitable for the applications within the scope of the present application.

The cured product may also exhibit an increased toughness over conventional epoxy resin thermosets. For example, the toughness of the resulting cured product made by the curable composition of the present invention is increased by at least 10 percent as compared with a cured product made from a curable composition having an epoxy reactive diluent.

The cured composite product of the present invention exhibits a Mode II toughness value, as measured by DIN 6034 of higher than about 500 J/m², preferably greater than about 1000 J/m², more preferably greater than about 2000 J/m², even more preferably higher than about 4000 J/m², and most preferably higher than about 6000 J/m². In one embodiment the upper fracture toughness of the thermoset composite product may be about 10000 J/m².

The cured composite product of the present invention exhibits an ultimate flexure strength value, as measured in accordance with ASTM D 790 of higher than about 40 MPa, preferably greater than about 100 MPa, more preferably greater than about 1000 MPa, even more preferably higher than about 3000 MPa, and most preferably higher than about 6000 MPa. In one embodiment the upper flexure strength of the cure thermoset composite product may be about 8000 MPa.

The cured thermoset product (not composite) of the present invention exhibits a strain to break value, as measured by ASTM D 790, of higher than about 1%, preferably greater than about 3%, more preferably greater than about 5%, even more preferably higher than about 10%, and most preferably higher than about 15%. In one embodiment the upper fracture toughness of the thermoset product may be about 20%.

The cured product of the present invention exhibits a modulus value, as measured by ASTM D 790, of greater than about 2 GPa, preferably greater than about 50 GPa, more preferably greater than about 100 Gpa, even more preferably greater than about 300 GPa, and most preferably greater than about 500 GPa. In one illustrative embodiment, the upper fracture toughness of the thermoset product may be about 900 GPa.

In one preferred embodiment, the cured composite product of the present invention has a fracture toughness as determined by End Notch Flexure of from about 500 J/m² to about 10000 J/m²; a modulus as determined by FLEXURE testing of from about 2 GPa to about 900 GPa; and a glass transition temperature as determined by DMTA of from about 50° C. to about 300° C.

### EXAMPLES

The following examples and comparative examples further illustrate the present invention in detail but are not to be construed to limit the scope thereof.

In the following Examples, various terms and designations are used such as for example:

“DVBDO” stands for divinylbenzene dioxide.

D.E.R. 383 is an epoxy resin having an EEW of 180 and commercially available from The Dow Chemical Company.

“BDDGE” stands for 1,4 butenediol diglycidyl ether which is a reactive diluent commercially available from Polystar.

“TETA” stands for triethylenetetraamine which is an amine curing agent commercially available from The Dow Chemical Company.

D.E.H.™ 20 is diethylenetetraamine which is an amine hardener commercially available from The Dow Chemical Company.

In the following Examples, standard analytical equipment and methods are used such as for example:

Dynamic mechanical analysis (DMA) is a method to measure Tg and modulus.

Flexure (ultimate flex strength) is measured by a universal testing machine as described in ASTM D790.

Mode II Fracture toughness at the composite level is measured using the End Notch Flexure test as described in DIN EN 6034.

Strain at break in flexure deformation mode is measured by a cross head displacement of a universal testing machine as described in ASTM D 790.

Modulus in flexure mode is calculated as per ASTM D790.

### Example 1 and Comparative Example A

A two part epoxy resin comprising of a blend of D.E.R. 383 and 14% BDDGE cured with a blend of aliphatic and cycloaliphatic amines—serves as the benchmark (Comparative Example A), is compared against a blend of D.E.R. 383 and DVBDO cured with a blend of amine hardeners (comprising of aliphatic and cycloaliphatic amines) [Example 11.

Composites were prepared using VARTM using glass fabric as the reinforcement. The resin mixture was pre-heated to 40° C. during infusion under full vacuum and then cured at 70° C. for 7 hours. The samples were cooled slowly after cure in order to reduce residual stresses.

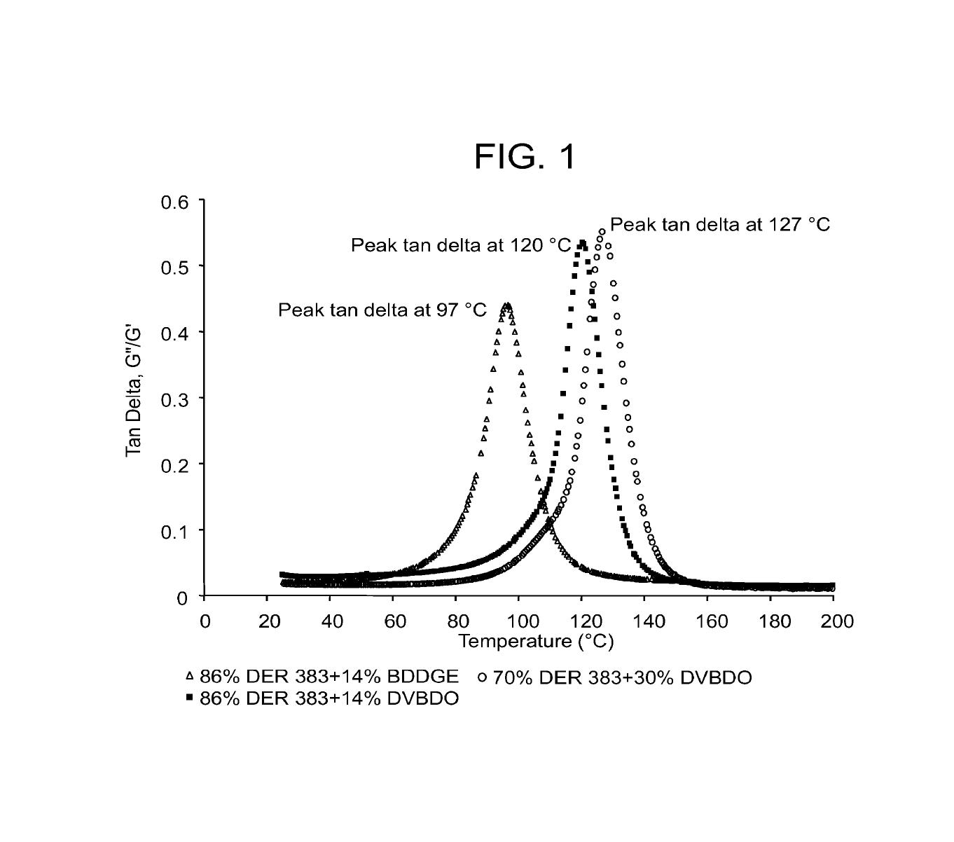

A number of tests including DMA, flexure and fracture were performed on the composite samples. A noticeable increase in Tg is recorded for the present invention as compared to the prior art (see FIG. 1). The other results of the tests are summarized below in Table I. Table I shows a comparison of composite data indicating improvements in strength as well as fracture toughness of samples made with DVBDO blended into the formulation.

TABLE I

| | | | Flex | | MODE |
|---|---|---|---|---|---|
| | | Flex | Strain | Flex | II |
| | | Strength | at Break | Modulus | GIIc |
| FORMULATION | EXAMPLE | (MPa) | (%) | (MPa) | (J/m\hat{ }2) |
| DER 383 + | Comparative | 639 | 3.76 | 22534 | 3590 |
| 14% BDDGE | Example A | | | | |
| DER 383 + | Example 1 | 651 | 3.89 | 21536 | 4243 |
| 14% DVBDO | | | | | |

### Example 2 and Comparative Example B

A two part epoxy resin comprising D.E.R. 383 cured with TETA (D.E.H.20) was compared to a sample comprising a blend of DVBDO with D.E.R. 383 cured with TETA.

In the case of the sample comprising DER 383+TETA (Comparative Example B), the starting viscosity was high (e.g. above about 1.5 Pa-s) and the rheo-kinetics very fast (e.g. viscosity higher than about 1 Pa-s in less than about 5 minutes) rendering the sample unusable for composite fabrication (implying that infusion of the resin through the dry reinforcement package was very difficult). When DVBDO was added to the DER 383+TETA formulation (Example 2), the starting viscosity was lowered (below about 1.5 Pa-s) and the system rheo-kinetics became favorable for processing via VARTM.

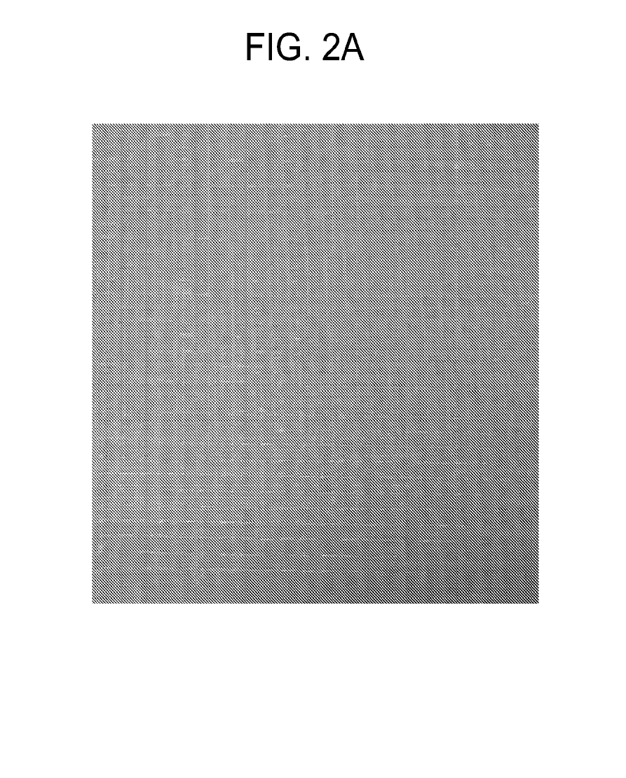

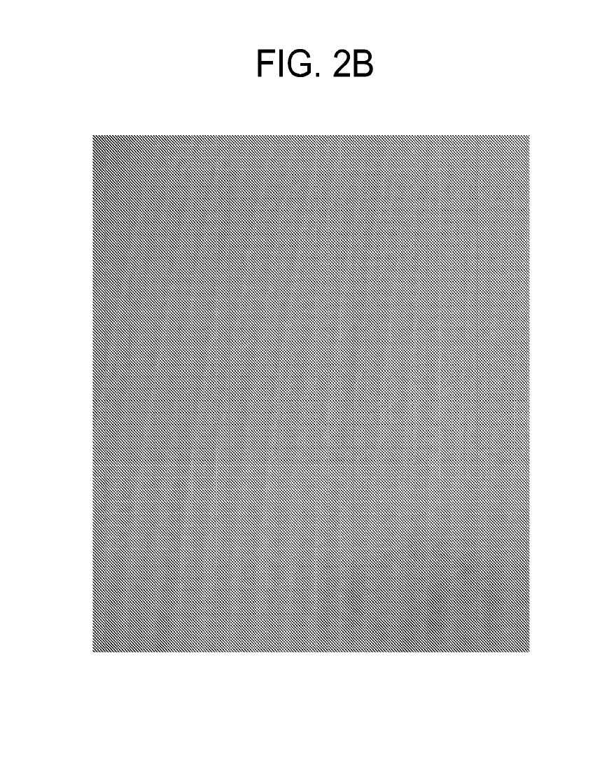

FIG. 2A shows, by visual inspection, defects (dry-regions and voids) in the composite of the comparative sample (Comparative Example B). FIG. 2B shows, by visual inspection, no defects (dry regions or voids) in the composite of the present invention (Example 2).

What is claimed is:

1. A diluent-free curable epoxy resin composition for preparing a composite comprising:
(A) at least one epoxy resin composition comprising a blend of:
(A1) at least one epoxy resin, and
(A2) at least one divinylarene dioxide;
(B) at least one hardener composition; and
(C) at least one reinforcement materials;
wherein the viscosity of the curable composition is the range of from about 0.15 Pa-s to about 1.5 Pa-s; and wherein the curable composition is adapted for providing a cured composite product made from the curable composition such that the composition being cured provides a cured composite product having an increased Tg of greater than about 5° C. as compared to a curable composition having a reactive diluent.

2. The curable epoxy resin composition of claim 1, wherein the curable composition is adapted for providing a cured composite product made from the curable composition such that the composition being cured provides a cured composite product having an increased modulus of greater than about 10 percent compared to a curable composition having a reactive diluent

3. The curable epoxy resin composition of claim 1, wherein the curable composition is adapted for providing a cured composite product made from the curable composition such that the composition being cured provides a cured composite product having an increased toughness of greater than about 5 percent.

4. The curable epoxy resin composition of claim 1, wherein the epoxy resin (A1) comprises diglycidyl ether of bisphenol A, diglycidyl ether of bisphenol F, a cycloaliphatic epoxy, oxazolidone-containing epoxy, or mixtures thereof; wherein the divinylarene dioxide resin (A2) comprises divinylbenzene dioxide resin; wherein the curing agent (B) comprises an amine; anhydride; phenolic; acid; or mixtures thereof; and wherein the reinforcement material (C) comprises fillers, fibers, fabrics, particulates, and mixtures thereof.

5. The curable epoxy resin composition of claim 1, wherein the reinforcement material (C) comprises fibers having an aspect ratio of from about 0.25 to about infinity (representing the continuous fiber case); or wherein the reinforcement material (C) comprises inorganic glass fibers, basalt, carbon and organic, Kevlar, polyolefins or hybrids thereof, or fillers selected from the group consisting of calcium carbonate, clay, wollastonite, and mixtures thereof.

6. The curable epoxy resin composition of claim 1, wherein the concentration of the epoxy resin (A1) comprises from about 40 weight percent to about 95 weight percent; wherein the concentration of divinylarene dioxide resin (A2) is from about 0.1 weight percent to about 50 weight percent; wherein the concentration of the curing agent (B) comprises from about 5 weight percent to about 60 weight percent; and wherein the concentration of reinforcement material (C) is from about 0.5 weight percent to about 95 weight percent.

7. The curable epoxy resin composition of claim 1, including a toughening agent or a curing catalyst.

8. The curable epoxy resin composition of claim 7, wherein the toughening agent comprises amphiphilic block copolymers, core shell rubbers, reactive liquid rubbers, inorganic fillers; or mixtures thereof.

9. The curable epoxy resin composition of claim 7, wherein the concentration of the toughening agent comprises from about 0.5 weight percent to about 35 weight percent.

10. The curable epoxy resin composition of claim 7, wherein the curing catalyst comprises of imidazoles, urons, epts, mpts, amines such as DMP 30 and Ancamine® K54; or mixtures thereof.

11. The curable epoxy resin composition of claim 7, wherein the concentration of the curing catalyst comprises from about 0.1 weight percent to about 5 weight percent.

12. A process for preparing a diluent-free curable resin composition or system comprising admixing:
(A) at least one epoxy resin composition comprising a blend of:
(A1) at least one epoxy resin, and
(A2) at least one divinylarene dioxide;
(B) at least one hardener composition; and
(C) at least one reinforcement materials;
wherein the viscosity of the curable composition is the range of from about 0.15 Pa-s to about 1.5 Pa-s at room temperature (25° C.); and wherein the curable composition is adapted for providing a cured composite product made from the curable composition such that the composition being cured provides a cured composite product having an increased Tg of greater than about 5° C. as compared to a curable composition having a reactive diluent.

13. A cured composite product preparing by curing the composition of claim 1; wherein the cured composite product has improved thermo-mechanical properties.

14. The cured composite product of claim 13, wherein the fracture toughness of the cured product as determined by End Notch Flexure comprises from about 500 J/m² to about 10000 J/m²; wherein the modulus of the cured product as determined by FLEXURE testing comprises from about 2 GPa to about 900 GPa; and wherein the glass transition temperature of the cured product as determined by DMTA comprises from about 50° C. to about 300° C.

15. A process for preparing cured composite product comprising of the steps of:
(a) preparing a curable epoxy resin composition comprising admixing.
(A) at least one epoxy resin composition comprising a blend of:
(A1) at least one epoxy resin, and
(A2) at least one divinylarene dioxide;
(B) at least one hardener composition; and
(C) at least one reinforcement materials;
wherein the viscosity of the curable composition is the range of from about 0.15 Pa-s to about 1.5 Pa-s; and wherein the curable composition is adapted for providing a cured composite product made from the curable composition such that the composition being cured provides a cured composite product having an increased Tg of greater than about 5° C. as compared to a curable composition having a reactive diluent; and
(b) curing the curable epoxy resin composition at a temperature of from about 20° C. to about 300° C.
